(19) United States
(12) Patent Application Publication
(10) Pub. No.: US 2014/0046491 A1
(43) Pub. Date: Feb. 13, 2014

(54) APPLICATION APPARATUS FOR APPLYING AN APPLICATION MEDIUM TO A COMPONENT

(71) Applicant: Peter Hoffmann, SchloB Holte-Stukenbrock (DE)

(72) Inventor: Peter Hoffmann, SchloB Holte-Stukenbrock (DE)

(73) Assignee: Durr Systems GmbH, Bietigheim-Bissingen (DE)

(21) Appl. No.: 13/996,764

(22) PCT Filed: Dec. 21, 2011
(86) PCT No.: PCT/EP11/06488

§ 371 Date: Sep. 12, 2013

(30) Foreign Application Priority Data
Dec. 23, 2010 (DE) 102010056071.5

(51) Int. Cl. G05D 7/06

(52) U.S. Cl. CPC G05D 7/0635
USPC 700/283

(57) ABSTRACT

An application apparatus is configured for application of a coating agent onto a component part, for example, for application of a sealing agent onto a body component. The application apparatus may include an elongated part, that is rotatable about its longitudinal axis and has a nozzle head with at least one nozzle to discharge the coating agent, and one valve unit to control the supply of the coating agent to the at least one nozzle. In a disclosed embodiment, the valve unit is formed outside the nozzle head and arranged at least in sections along the elongated part in a direction of the nozzle head.

An application apparatus may be used for application of a coating agent onto a component part, for example, for application of a sealing agent onto a body component.

EP 1 521 642 A1 describes an application apparatus for application of a fluid. The application apparatus comprises an elongated rotatable lance, which has at one end a nozzle head with one or more nozzles. Each of the nozzles is assigned to a valve unit, respectively, so that a plurality of valve units is required. The valve units are arranged in the rotatable nozzle head. DE 103 45 840 A1 describes a device for application of a fluid onto the surface of a workpiece. The device comprises a rotatable shaft, at the end of which is arranged an application nozzle, and a valve unit, which is carried out as an on/off valve and is positioned at the end of the shaft opposite the application nozzle. As general technological background, reference is also made to U.S. Pat. No. 6,705,537 B2 and DE 10 2007 053 578 A1.

Disclosed herein is an improved and/or alternative application apparatus for application of coating agent to a component part.

In general, a valve unit may be arranged outside a nozzle head and/or adjacent to a nozzle head, e.g., in such a manner that the valve unit is arranged closer to the nozzle head than to one end of the elongated part opposite the nozzle head and/or in such a manner that the valve unit is arranged at least in sections along the elongated part in the direction of the nozzle head.

An application apparatus for application of a coating agent onto a component part, e.g., for application of a sealing agent onto a body component, may be created. The application apparatus can comprise an elongated part that is rotatable about its longitudinal a83375453xis and has a nozzle head with at least one nozzle in order to apply the coating agent. The application apparatus can further comprise a valve unit in order to control the supply of the coating agent to the at least one nozzle.

The term “control” as used herein generally means, without limitation, “adjusting” and/or “adjustment,” including, for example, “regulating” and/or “regulation.”

It is possible that the valve unit is arranged outside the nozzle head and/or (e.g., at least in sections) is arranged along the elongated part in the direction of the nozzle head (e.g. essentially parallel or at any angle relative to the elongated part), and may extend along the elongated part to the nozzle head.

The valve unit may be arranged at least in sections along the elongated part in the direction of the nozzle head. For example, the valve unit may extend at least in sections essentially parallel to the elongated part and/or the valve unit may extend at least in sections at an angle or slanted (e.g. at right angle, at acute angle, transverse, etc.) relative to the elongated part. The same applies also, for example, to the rotatable needle described below, the axially shiftable sleeve and/or the motor described below.

Advantageously, a responsive application apparatus, e.g., including a reduced valve system, may be provided. Furthermore, an advantageously easily structured application apparatus may be provided, and moreover, a quantity-adjustable supply of coating agent may be provided to the at least one nozzle, e.g., advantageously to a plurality of nozzles at a same coating agent pressure.

It is possible that the coating agent can be led by means of rotary passage from the valve unit into the elongated part.

It is possible that the valve unit is arranged at least in sections radially beside the elongated part and/or the nozzle head.

It is possible that the valve unit is arranged closer to the nozzle head than to the end of the elongated part opposite the nozzle head.

It is possible that the fixing apparatus described below or another functional agent is formed at the end of the elongated part opposite the nozzle head.

It is possible that the valve unit is arranged at least in sections along the nozzle-head side half, the nozzle-head side third, the nozzle-head side fourth and/or the nozzle-head side fifth of the elongated part. In particular, the valve unit may be formed abutting or adjacent to the nozzle head. It is possible that the valve unit is thereby arranged closer to the nozzle head than to the end of the elongated part opposite the nozzle head.

For example, the distance between the valve unit and the at least one nozzle can be smaller than 100 cm, 50 cm, 25 cm, 20 cm, 15 cm, 10 cm, 7.5 cm, 5 cm, 2.5 cm, 1.0 cm or 0.5 cm.

The valve unit can correspond to an outlet valve with the advantage that a delay can be avoided between the control unit, and/or the valve unit and the pneumatic shutter.

It is possible that the elongated part comprises, at the end opposite the nozzle head, a fixing apparatus by means of which the elongated part can be fastened to another part, e.g., indirectly or directly to a robot arm, e.g., to an end face of a robot arm.

It is possible that the valve unit is attached to or arranged on the outer circumference of the elongated part.

It is possible that the valve unit comprises a valve housing in which the valve mechanism (described further below) is accommodated.

The valve unit and/or the valve housing are stationary relative to the elongated part.

The elongated part can be realized as a one-part or multiple-part element.

It is possible that the at least one nozzle comprises a plurality of nozzles, in particular at least two or at least three nozzles.

It is possible that one and the same valve unit is assigned to a plurality of nozzles.

For example, the valve unit is suitable to control the supply of the coating agent optionally to one of the plurality of nozzles.

It is possible that the valve unit is furthermore suitable to control the supplied quantity of the coating agent to one of the plurality of nozzles in an adjustable manner, e.g., at essentially a same coating agent pressure as the other nozzles. Here, it is possible that, at the same coating agent pressure, the opening angle preferably created by a rotatable needle regulates the supplied quantity of the coating agent and/or the coating agent flow.

The valve unit can be realized as an on/off valve unit. Here, the valve unit may be suitable to be controlled from a fully opened position to a fully closed position and/or vice versa.

The valve unit can be realized as a quantity-adjustable (comprising a quantity-controllable and/or quantity-regulatable) valve unit. Here, the valve unit may be suitable to be controlled to one or more intermediate positions between a fully opened position and a fully closed position. The valve unit can thus advantageously be located, besides a fully opened position and a fully closed position, also at one or more intermediate positions.

The valve unit furthermore may be suitable to control the supply of the coating agent to a return line for recycling of the coating agent.

It is possible that the valve unit comprises an inlet duct and/or an inlet opening for the coating agent in order to insert the coating agent into the valve unit.

Furthermore, the valve unit can comprise a plurality of coating agent ducts, which can be respectively assigned to one of the nozzles.

It is possible that the plurality of coating agent ducts can be supplied with the coating agent via one and the same inlet duct of the valve unit.

It is possible that coating agent to be recycled can be led through the valve unit into a return line for recycling of the coating agent, e.g., transversely through a rotatable needle of the valve unit or via a preferably pneumatic valve, which is expediently arranged in the valve unit.

Preferably, at least one supply line is formed in the elongated part for the supply of the coating agent to a nozzle.

It is possible that at least one coating agent duct can be connected with at least one supply line formed in the elongated part for the supply of the coating agent to a nozzle, preferably by means of a rotary passage.

It is possible that a coating agent duct can be connected, or is connected, (e.g., by a rotary passage) with a supply line for the supply of coating agent to a nozzle, and another coating agent duct can be connected, or is connected, (e.g., by the rotary passage) with another supply line for the supply of coating agent to another nozzle.

Furthermore, another coating agent duct can be connected, or is connected, with a return line for recycling of the coating agent.

It is possible that a coating agent duct can thus respectively be assigned to a specific nozzle and/or a specific supply line and/or the return line.

The valve unit may have a valve mechanism. The valve mechanism is may be accommodated in the valve housing.

It is possible that the valve unit, e.g., the valve mechanism, comprises a rotatable needle (valve needle) and/or an axially shiftable sleeve, or a plurality of preferably pneumatic valves, in particular needle valves. The valve unit can thus be implemented as a slide valve unit or as a pneumatic valve unit.

A valve may be respectively assigned to a nozzle. For example, the valves can control the supply of coating agent to the nozzles in a quantity-adjustable manner. It is, however, also possible that the valve are carried out as on/off valves (i.e. only switchable between a fully opened and a fully closed position). In particular, the valves may be arranged in the valve housing. Expediently, in each case, one valve can be arranged in respectively one coating agent duct. The valves are preferably pneumatic valves, in particular needle valves.

In addition, the valve unit can comprise a valve, in particular a return valve. The valve is expediently formed to control the supply of the coating agent to the return line. The valve may be a pneumatic valve, e.g., a needle valve. The valve is expediently arranged in the valve housing.

It is possible that the valves and/or the nozzles can be supplied with the coating agent from one and the same supply line or duct. It is possible that the supply duct extends in the valve unit and is, e.g., connected with the coating agent duct and/or the return line.

It is possible that the rotatable needle and/or the axially shiftable sleeve comprise recesses for the passage of the coating agent.

It is possible that, depending on an angular and/or rotational position the rotatable needle and/or depending on an axial position of the shiftable sleeve, the supply of the coating agent to one of the plurality of nozzles is optional and can be controlled and/or the supplied quantity of the coating agent to one of the plurality of nozzles can be controlled in an adjustable manner.

Furthermore, depending on an angular and/or rotational position of the rotatable needle and/or depending on an axial position of the shiftable sleeve, the supply of the coating agent to a return line for recycling of the coating agent can be controlled.

It is possible that the application apparatus comprises one temperature sensor and/or one pressure sensor for the coating agent, which can be connected with the valve unit. Furthermore, the application apparatus, e.g., the valve unit, can optionally comprise a heating device.

The application apparatus e.g., including the valve unit can comprise a motor (e.g., a servomotor, electric motor, direct current motor, etc.), which preferably extends along the elongated part, e.g., essentially parallel or inclined (e.g. transverse, at a right angle, at an acute angle, etc.).

The motor can be connected with the valve unit, e.g., to turn the needle.

Furthermore, the application apparatus e.g., including the valve unit can comprise one pneumatic apparatus, which can be connected with the valve unit in order to shift the sleeve axially.

It is possible that a coupling can be arranged between the motor and the valve unit, in particular the rotatable needle, for compensation of misalignments.

It is possible that no rotary passage is required upstream of the valve unit.

It is possible that the coating agent can be led without any rotary passage into the valve unit and can be inserted without previously passing a rotary passage into the valve unit, in particular the inlet opening and/or the inlet duct of the valve unit. Furthermore, it is possible that the coating agent can be led without any rotary passage from the valve unit into a return line for recycling of the coating agent and/or can be led without having previously passed a rotary passage from the valve unit into the return line.

It is possible that the valve unit comprises an inlet connection for a hose-like supply line via which the coating agent can be led into the valve unit.

It is likewise possible that the valve unit comprises an outlet connection for a hose-like return line via which the coating agent to be recycled can be led into the return line.

The return line may be a circulation line.

It is possible that at least two of the following are aligned essentially parallel to one another and/or coaxially with respect to one another and/or at an angle (e.g. inclined, transverse, at a right angle, at an acute angle, etc.): the elongated part, the rotatable needle, the axially shiftable sleeve, the valve unit, a robot arm, the motor.

It is possible that the valve unit, the motor and/or the rotary passage as well as, optionally, the coupling, the temperature gauge, the pressure sensor and/or the heating device form a functional unit.

The functional unit can advantageously be arranged outside the elongated portion and/or arranged at least in sections along the elongated part in the direction of the nozzle head. It is possible that the functional unit is formed radially near the elongated part.

It is furthermore possible that the functional unit is arranged at least in sections along the nozzle-head side half, the nozzle-head side third, the nozzle-head side fourth and/or the nozzle-head side fifth of the elongated part.

In particular, the functional unit is attached to and/or arranged on the outer circumference of the elongated part and/or arranged next to the nozzle head.

It is possible that the valve unit and/or the functional unit are held by a holding and/or fixing apparatus and/or held stationary in particular relative to the elongated part.

It is possible that a holding and/or fixing apparatus can be fastened to a part of the application apparatus other than the elongated part, e.g., to a robot arm.

It is possible that the valve unit as such does not extend around the elongated part, but is arranged on one side only of the elongated part, although it is also possible that parts of the valve unit (e.g. holding means and/or a rotary passage) are arranged around the elongated part.

The above features and embodiments can generally be combined with one another in any desired manner. Other advantageous developments may be dislcosed in the following description, figures, and claims relating to the exemplary embodiments.

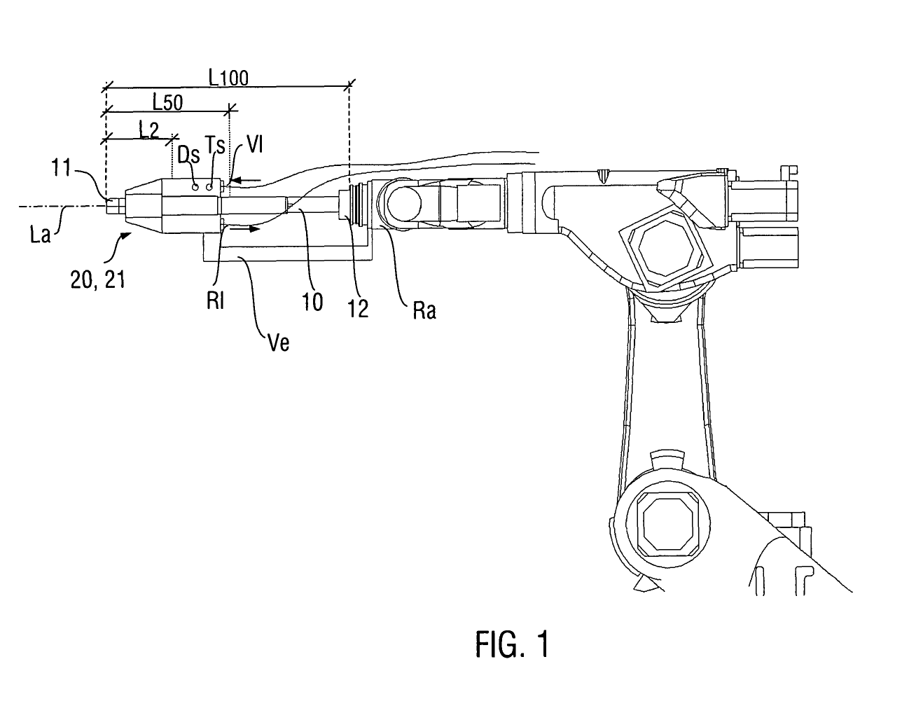

FIG. 1 shows a side view of an application apparatus according to an exemplary embodiment,

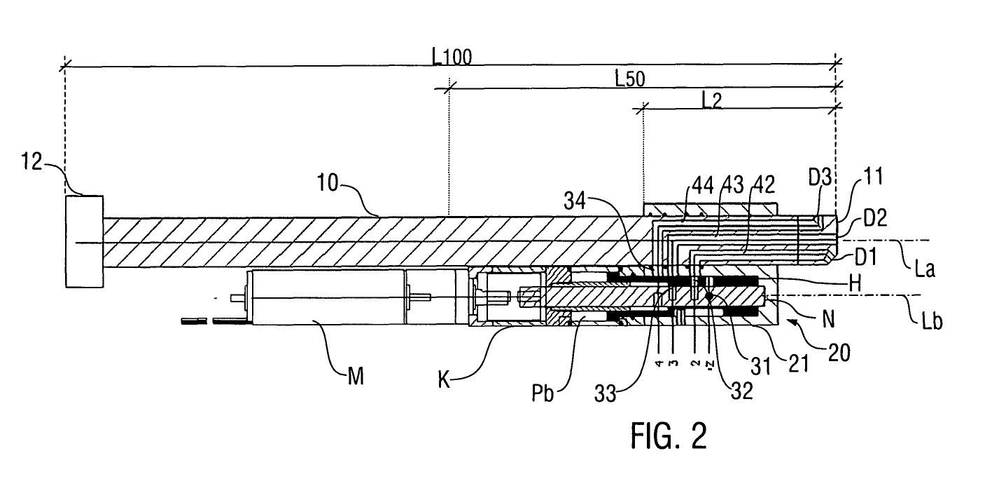

FIG. 2 shows a longitudinal section of an elongated rotatable part and of a valve unit of the application apparatus shown in FIG. 1,

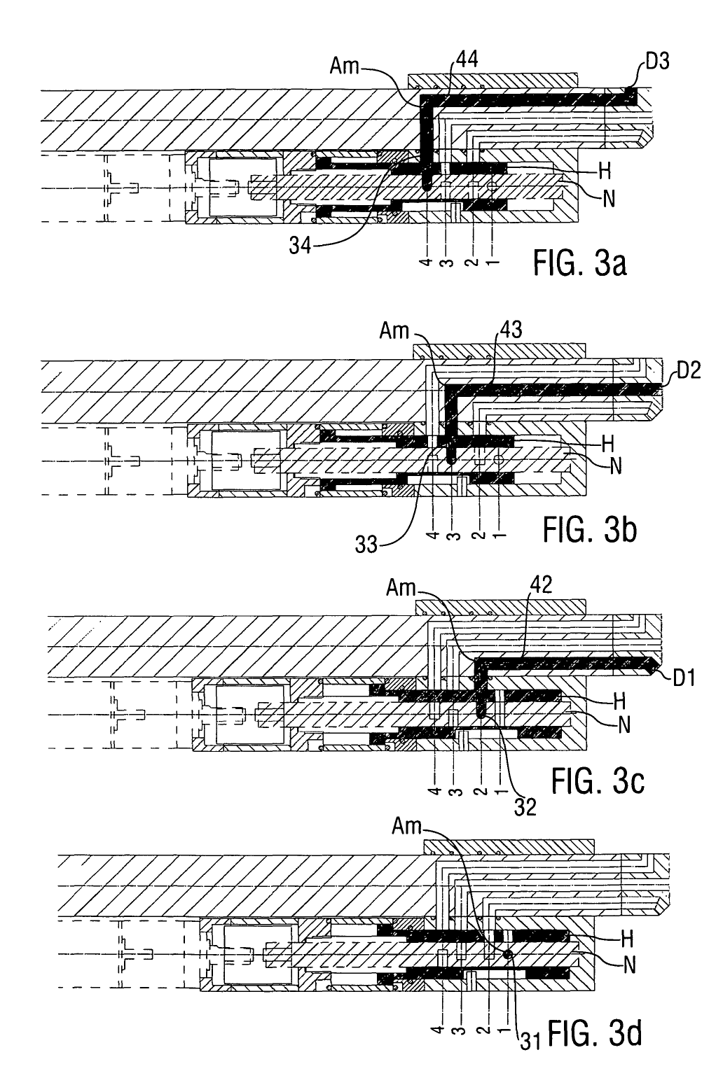

FIGS. 3a-3d show longitudinal sections of the elongated rotatable part and of the valve unit, wherein the valve unit is shown in different operating modes,

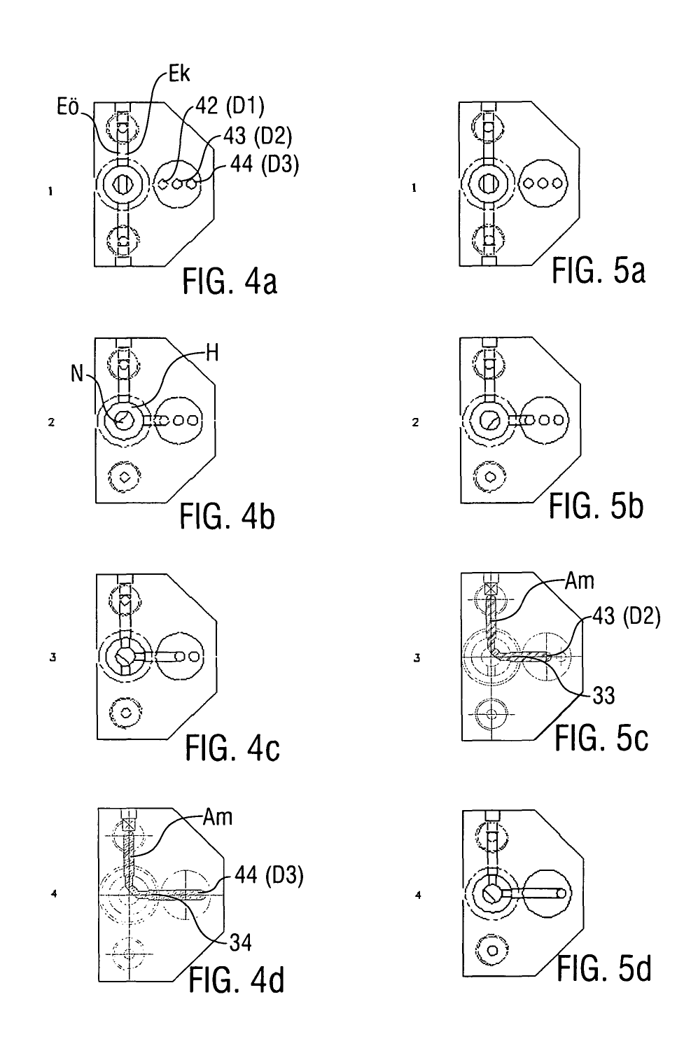

FIGS. 4a-4d show different cross-sectional views of the elongated rotatable part and of the valve unit, wherein the elongated rotatable part and the valve unit are cut at axially spaced locations,

FIGS. 5a-5d show different cross-sectional views of the elongated rotatable part and of the valve unit, wherein the elongated rotatable part and the valve unit are cut at axially spaced locations,

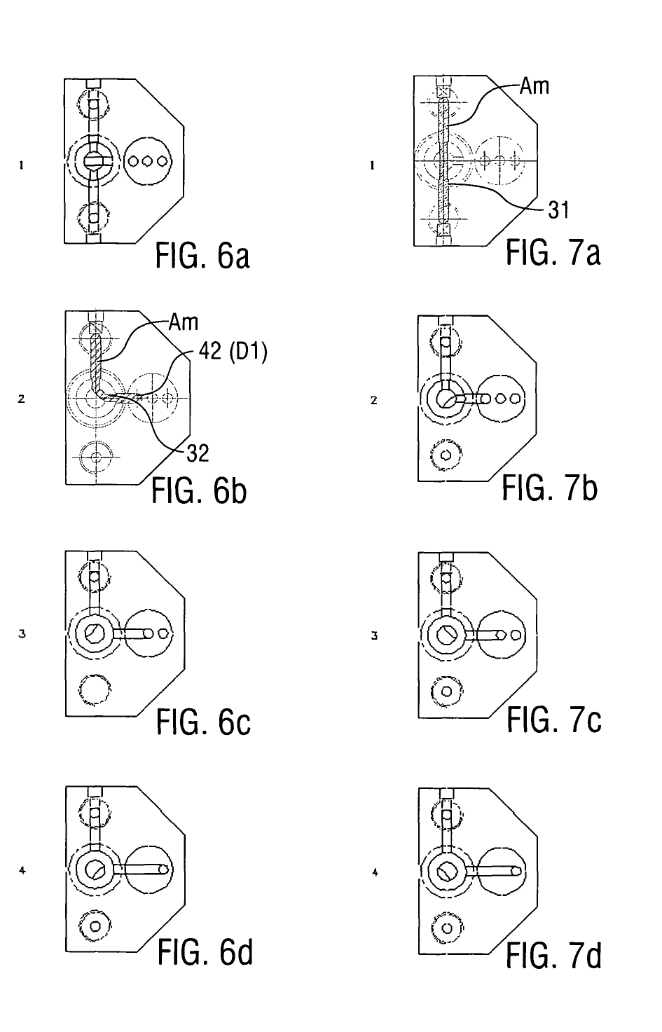

FIGS. 6a-6d show different cross-sectional views of the elongated rotatable part and of the valve unit, wherein the elongated rotatable part and the valve unit are cut at axially spaced locations,

FIGS. 7a-7d show different cross-sectional views of the elongated rotatable part and of the valve unit, wherein the elongated rotatable part and the valve unit are cut at axially spaced locations,

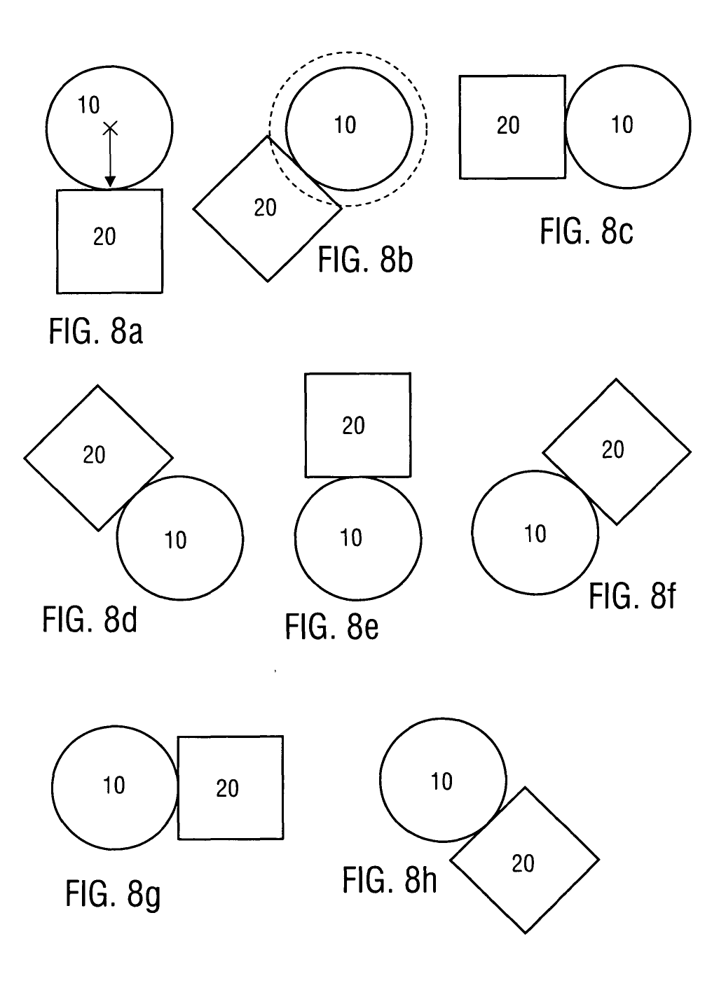

FIGS. 8a-8h show highly schematic resp. simplified cross sectional views of the elongated rotatable part and of the valve unit, which is arranged according to different embodiments radially near the elongated rotatable part, and

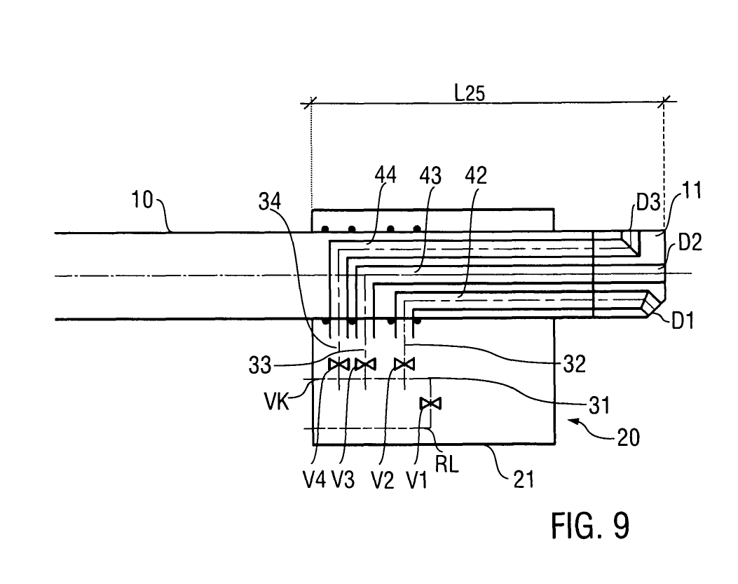

FIG. 9 shows a schematic side view of an application apparatus according to an exemplary embodiment.

FIG. 1 shows a side view of an application apparatus for application of a coating agent, e.g., a sealing agent. The application apparatus comprises an elongated part 10, which is rotatable about its longitudinal axis La and has a nozzle head 11 with three nozzles D1, D2, D3 (see, e.g., FIG. 2) configured to apply the coating agent. Furthermore, the application apparatus comprises one valve unit 20 with a valve mechanism configured to control the supply of the coating agent to the nozzles D1, D2, D3.

The valve unit 20 is accommodated in a valve housing 21. The valve unit 20 is arranged outside the nozzle head 11 and formed in sections along the elongated part 10 in the direction of the nozzle head 11. The valve unit 20 extends along the elongated part 10 in the direction of the nozzle head 11 and is arranged radially next to the elongated part 10.

A hose-shaped supply line V1 is provided in order to supply the coating agent of the valve unit 20, whereas a recycling or circulation line R1 is provided in order to recycle a coating agent to be recycled from the valve unit 20. The arrows shown in FIG. 1 show a direction of flow of the coating agent.

The elongated part 10 has at a first axial end the nozzle head 11, and at a second axial end a fixing apparatus 12 in order to fasten the elongated part 10 indirectly or directly to a robot arm Ra. The elongated part 10, inclusive of the nozzle head 11 and the fixing apparatus 12, has a length, which is identified by L100. As can be seen in FIG. 1, the valve unit 20 extends along a nozzle-head side half L50, possibly including a nozzle-head side fourth L25 of the elongated part 10, and is arranged next to the nozzle head 11 to be positioned closer to the nozzle head 11 than at the second axial end that is opposite the nozzle head 11 and/or at which the fixing apparatus 12 is generally located.

The reference sign Ds identifies a pressure sensor, whereas the reference sign Ts identifies a temperature sensor for the coating agent.

FIG. 2 shows a longitudinal section of a part of the application apparatus from FIG. 1. The coating agent may be be inserted into the valve unit 20 without having previously passed a rotary passage, e.g., no rotary passage is required upstream of the valve unit 20.

As can be seen in FIG. 2, the valve unit 20 comprises a plurality of coating agent ducts 31, 32, 33, 34, which can be connected by a rotary passage with a plurality of supply lines 42, 43, 44 formed in the elongated part 10 for the supply of the coating agent to the nozzles D1, D2, D3.

The coating agent duct 34 can be connected with the supply line 44 to supply a coating agent to the nozzle D3. The coating agent duct 33 can be connected with the supply line 43 to supply a coating agent to the nozzle D2. The coating agent duct 32 can be connected with the supply line 42 to supply a coating agent to the nozzle D1. The coating agent duct 31 can be connected with the return line R1 to supply a coating agent to the return line F1.

FIG. 2 shows in particular the valve mechanism, which comprises an axially shiftable sleeve H and a needle N that can be rotated by means of a motor M, the needle being coaxially accommodated in the sleeve H. The rotatable needle N and the axially shiftable sleeve H have recesses for the passage of the coating agent.

As can be seen in FIG. 2, not every nozzle D1, D2, D3 is assigned respectively to a separate valve unit. Instead, one and the same valve unit 20 and/or one and the same valve mechanism may be assigned to the nozzles D1, D2, D3 and is suitable to control the supply of the coating agent that may optionally be supplied to one of the plurality of nozzles D1, D2, D3 and optionally likewise to control the supply of the coating agent to one of the plurality of nozzles D1, D2, D3 in a quantity-adjustable manner.

For example, the supply of the coating agent optionally to one of the plurality of nozzles D1, D2, D3 can be controlled depending on an angular position of the rotatable needle N and depending on an axial position of the shiftable sleeve H and, furthermore, the supplied quantity of the coating agent to one of the plurality of nozzles D1, D2, D3 can be controlled in an adjustable manner, wherein the latter can be realized in particular depending on the angular position of the rotatable needle N.

Furthermore, the supply of the coating agent from the valve unit 20 to the return line R1 can be controlled.

In addition, FIG. 2 shows a coupling K that is arranged between the rotatable needle N and the motor M to compensate for misalignments. The reference sign Pb identifies a pneumatic area for the lifting movement of the axially shiftable sleeve H.

The reference sign Lb identifies a longitudinal or central axis of the needle N, the sleeve H and of the motor M, which are arranged coaxially with respect to one another.

The elongated part 10 and the needle N, the sleeve H and the motor M are preferably aligned essentially parallel to one another, but they can also extend towards one another at a certain angle (e.g. inclined or at right angle).

The FIGS. 3a-3d show longitudinal sections of the valve unit 20 and of the elongated part 10, wherein the valve unit 20 is shown in different operational positions. In particular, FIGS. 3a-3d show the axially shiftable sleeve H in different axial positions and the rotatable needle N in different angular and/or rotational positions. The reference sign Am identifies the coating agent.

In FIG. 3a, the valve unit 20 is provided such that the coating agent Am is led from the coating agent duct 34 to the supply line 44 and the nozzle D3.

In FIG. 3b, the valve unit 20 is provided such that the coating agent Am is led from the coating agent duct 33 to the supply line 43 and the nozzle D2.

In FIG. 3c, the valve unit 20 is provided such that the coating agent Am is led from the coating agent duct 32 to the supply line 42 and the nozzle D1.

In FIG. 3d, the valve unit 20 is provided such that the coating agent Am is led from the coating agent duct 31 through the valve unit 20, e.g., transversely through the rotatable needle N, into the return line R1.

FIGS. 4a-4d, 5a-5d, 6a-6d and 7a-7d show cross-sectional views of the valve unit 20 at different axial positions, wherein, for the sake of clarity, not all figures are provided with reference signs. In particular, the axially shiftable sleeve H is shown in different axial positions and the rotatable needle N is shown in different angular and/or rotational positions.

In FIG. 4a, an inlet opening Ek, and an inlet duct Ek, for inserting the coating agent Am into the valve unit 20 are furthermore identified, wherein the plurality of coating agent ducts 31, 32, 33, 34 can be supplied with the coating agent Am via the inlet opening Eö and the inlet duct Ek.

FIG. 3a corresponds with FIG. 4d. In FIG. 3a, the axially shiftable sleeve H is retracted (“left” position in FIG. 3a). The angular and/or rotational position of the rotatable needle N and the axial position of the shiftable sleeve H generally ensure that the coating agent Am is led to the nozzle D3, which can be seen in FIG. 4d, and further to the positions shown in FIGS. 4a-4c.

FIG. 3b corresponds with FIG. 5c. In FIG. 3b, the axially shiftable sleeve H is retracted (“left” position in FIG. 3b). The angular and/or rotational position of the rotatable needle N and the axial position of the shiftable sleeve H generally ensure that the coating agent Am is led to the nozzle D2, which can be seen in FIG. 5c, and further to the positions shown in FIGS. 5a, 5b, 5d.

FIG. 3c corresponds with FIG. 6b. In FIG. 3c, the axially shiftable sleeve H is extended (“right” position in FIG. 3c). The angular and/or rotational position of the rotatable needle N and the axial position of the shiftable sleeve H generally ensure that the coating agent Am is led to the nozzle D1, which can be seen in FIG. 6b, and further to the positions shown in FIGS. 6a, 6c, 6d.

FIG. 3d corresponds with FIG. 7a. In FIG. 3d, the axially shiftable sleeve H is extended (“right” position in FIG. 3d). The angular and/or rotational position of the rotatable needle N and the axial position of the shiftable sleeve H generally ensure that the coating agent Am is led via the coating agent duct 31 to the return line R1, which can be seen in FIG. 7a, and further to the positions shown in FIGS. 7a-7d.

FIGS. 8a-8h show highly schematic and/or simplified cross sectional views of the elongated rotatable part 10 and of the valve unit 20. The valve unit 20 is arranged according to different embodiments, e.g., radially near the elongated part 10, e.g. in FIG. 8a below the elongated part 10, in FIG. 8e above the elongated part 10, in FIGS. 8c, 8g to the side of the elongated part 10 and in the remaining figures in any intermediate arrangements. As is apparent from FIGS. 8a-8h, the valve unit 20 can be arranged at any position near the elongated part 10. In FIG. 8b, a rotary passage is indicated in a highly schematic and/or simplified manner by a dashed line, which passage may extends wholly or at least for the most part around the outer circumference of the elongated part 10.

FIG. 9 shows a schematic side view of an application apparatus according to another exemplary embodiment. The exemplary embodiment described with reference to FIG. 9 partially conforms with the exemplary embodiment described with reference to FIGS. 1 to 8, wherein similar or identical parts are provided with the same reference sign and, to avoid repetitions, reference is also made to the above description for an explanation about them.

The valve unit 20 shown in FIG. 9 includes a plurality of valves V2, V3, V4. The valve V4 is arranged in the coating agent duct 34 and assigned to the nozzle D3, the valve V3 is arranged in the coating agent duct 33 and assigned to the nozzle D2 and the valve V2 is arranged in the coating agent duct 32 and assigned to the nozzle D1. The valves V2, V3 and V4 are carried out as pneumatic needle valves to control the supply of the coating agent to the nozzles D1, D2 and D3, e.g., in a quantity-adjustable manner.

The valve unit 20 shown in FIG. 9 has in addition a return valve V1, which expediently controls a supply of the coating agent to a return line RL for recycling of the coating agent. The return valve V1 is carried out as a pneumatic needle valve.

The valves V2, V3 and V4 and thus the nozzles D1, D2 and D3 as well as the return valve V1 can be supplied with the coating agent from one and the same supply duct or line Rk, R1. The valves V1, V2, V3 and V4 are accommodated in one and the same valve housing 21.

It is apparent that the valve unit 20 can be carried out, for example, as a slide valve unit or as a pneumatic valve unit comprising a plurality of valves.

The invention is not limited to the preferred exemplary embodiments described above. Instead, a plurality of variants and modifications is possible, which also make use of the concept of the invention and therefore fall within the scope of protection. The invention is limited only by the following claims.

1. An application apparatus for application of a coating agent onto a component, comprising:
a) an elongated part that is rotatable about a longitudinal axis and that includes a nozzle head having with at least one nozzle configured to discharge the coating agent, and
b) valve unit that is configured to control the supply of the coating agent to the at least one nozzle,
wherein:
c) the valve unit is formed outside the nozzle head and is arranged at least in sections along the elongated part in a direction of the nozzle head.

2.-21. (canceled)

22. The application apparatus of claim 1, wherein the valve unit:
is arranged adjacent to the nozzle head,
extends at least in sections along a half of the elongated part proximate to the nozzle head, and
extends along the elongated part in the direction of the nozzle head.

23. The application apparatus of claim 1, wherein the valve unit:
is arranged outside the elongated part, and
is arranged radially beside the elongated part.

24. The application apparatus of claim 1, wherein the valve unit is arranged radially beside the nozzle head.

25. The application apparatus of claim 1, wherein:
the valve unit is accommodated in a valve housing, the valve housing being stationary with respect to the elongated part, and
a rotary passage from the valve unit into the elongated part is provided for the coating agent.

26. The application apparatus of claim 1, wherein the at least one nozzle comprises a plurality of nozzles.

27. The application apparatus of claim 1, wherein the valve unit:
is assigned to a plurality of nozzles,
is configured to control the supply of the coating agent to one of the plurality of nozzles,
is configured to provide a quantity-adjustable supply of the coating agent to one of the plurality of nozzles, and
is configured to control the supply of the coating agent to a return line for recycling of the coating agent.

28. The application apparatus of claim 1, wherein the elongated part comprises a fixing apparatus on an end opposite from the nozzle head.

29. The application apparatus of claim 1, wherein the valve unit comprises:
at least one of an inlet duct and an inlet opening for the coating agent, and
a plurality of coating agent ducts, wherein the plurality of coating agent ducts are configured to be supplied with coating agent via at least one of the inlet duct and the inlet opening.

30. The application apparatus of claim 1, wherein the valve unit is configured for passage of the coating agent to be recycled.

31. The application apparatus of claim 1, wherein:
a first coating agent duct of the valve unit is configured to be connected with a supply line formed in the elongated part for supply of the coating agent to a first nozzle and a second coating agent duct of the valve unit is configured to be connected with another supply line formed in the elongated part for supply of the coating agent to second nozzle, and
a coating agent duct of the valve unit is configured to be connected with a return line for recycling of the coating agent.

32. The application apparatus of claim 1, wherein the valve unit comprises a plurality of valves, further wherein each valve is respectively assigned to one of a plurality of nozzles.

33. The application apparatus of claim 33, wherein the valves are formed as pneumatic valves.

34. The application apparatus of claim 33, wherein the valves are accommodated in a single valve housing.

35. The application apparatus of claim 33, configured such that at least one of the valves is supplied with the coating agent from a single supply duct.

36. The application apparatus of claim 1, wherein the valve unit includes a valve configured to control a supply of the coating agent to a return line for recycling of the coating agent.

37. The application apparatus of claim 1, wherein:
the valve unit comprises a rotatable needle and an axially shiftable sleeve,
the rotatable needle is accommodated in sections in the axially shiftable sleeve, and
the rotatable needle and the axially shiftable sleeve comprise recesses for passage of the coating agent.

38. The application apparatus of claim 1, wherein, depending on an angular position of the rotatable needle and an axial position of the shiftable sleeve:
supply of the coating agent to one of the plurality of nozzles can be controlled,
supply of the coating agent to one of the plurality of nozzles is adjustable with respect to a quantity of the coating agent supplied, and
supply of the coating agent to a return line for recycling of the coating agent can be controlled.

39. The application apparatus of claim 1, wherein the valve unit:
is connected with a motor that is configured to rotate the needle, and
is connected with a pneumatic apparatus configured to shift the sleeve axially.

40. The application apparatus of claim 39, wherein:
the motor extends along the elongated part, and
a coupling is arranged between the motor and the valve unit to effect compensation of misalignments.

41. The application apparatus of claim 1, wherein:
no rotary passage is arranged upstream of the valve unit,
the coating agent can enter and exit the valve unit without rotary passage.

42. The application apparatus of claim 1, wherein the valve unit, the motor and the coupling form a functional unit arranged adjacent to the nozzle head or outside the elongated part.
